(19) United States
(12) Patent Application Publication
(10) Pub. No.: US 2016/0364231 A1
(43) Pub. Date: Dec. 15, 2016

(54) METHOD FOR MINIMAL SERVICE IMPACT DURING SOFTWARE UPGRADE IN NETWORK ELEMENTS (NES)

(71) Applicant: Telefonaktiebolaget L M Ericsson (publ), Stockholm (SE)

(72) Inventors: Srikar TATI, San Jose, CA (US); Vijayaraghavan BHARATHI, San Jose, CA (US); Peter J. OWENS, San Jose, CA (US)

(21) Appl. No.: 14/735,483

(22) Filed: Jun. 10, 2015

(51) Int. Cl. G06F 9/445

(52) U.S. Cl. CPC G06F 8/67

(57) ABSTRACT

Exemplary methods include in response to receiving an indication to perform an in-service software upgrade (ISSU), an init process executing on a current root file system is configured to perform operations comprising: 1) releasing the current root file system by setting an indication that the ISSU is in progress, and terminating processes executing on the current root file system, and 2) switching from the current root file system to a new root file system by moving a root from the current root file system to the new root file system, moving critical system files from the current root file system to the new root file system, unmounting the current root file system, and executing an init process on the new root file system. The init process executing on the new root file system is configured to perform operations comprising starting processes on the new root file system.

### FIELD

Embodiments of the invention relate to the field of packet networks, and more specifically, to in-service software upgrade (ISSU) of a network device with minimal service impact.

### BACKGROUND

A network device in a network (e.g., a service provider or core network) typically handles high volumes of data traffic from users (e.g., subscribers) accessing several different services and/or communicating with other users. For example, a network device can handle services for up to thousands of users. An interruption in the operation of such a network device can cause a disruption of service to these thousands of users. It should be further noted that an interruption in the operation of the network device also imposes stress on its adjacent network devices and the network as a whole.

In the course of handling the data for this large number of users, a network device builds up a state that controls the handling of the data. This state is typically run-time information that does not survive a reboot of the network device. Periodically, a network device receives a software upgrade to its services. Typically, a software upgrade requires a reboot of the network device in order for the software upgrade can take effect. A reboot, however, disrupts the service and clears out the built up state, because the state does not survive a reboot. Even though a reboot of a network device can occur quickly, the rebuilding of the state typically takes longer, because rebuilding of the state involves reconnecting subscribers, rebuilding subscriber session information, establishing the communication channel between the peer network devices, rebuilding the forwarding tables from the exchanged information and from the local configuration, synchronizing the forwarding tables across network devices, etc. Thus, a reboot can result in a disruption of services for a substantial period of time.

An improved software upgrade method, termed an in-service software upgrade (ISSU), is used in order to minimize disrupting the service. During an ISSU, the software modules are upgraded in parts (i.e., not all software modules are upgraded at the same time). If ISSU is achieved without disrupting any network traffic, then it is said to have achieved a condition of Zero Packet Loss (ZPL). Otherwise, if there is a minimal disruption of traffic without disconnecting the network device from the neighbor nodes, then ISSU is said to have achieved the condition of Zero Topology Loss (ZTL). Network devices that have redundancy for all the modules can usually realize the ZPL state; otherwise they can only accomplish ZTL.

Some conventional implementations of ISSU provide solutions that require redundant components of the modules, resulting in high cost solutions. Other conventional implementations of ISSU require hardware resets in network device, resulting in an extended period of service interruption. Some conventional implementations of ISSU require a restart of the kernel of the network device, which also results in an extended period of service disruption. In yet other conventional implementations of ISSU, the forwarding traffic is not interrupted at all. However, this is possible because of the microkernel nature of the operating system, and does not work when the network device employs a modular kernel system.

### SUMMARY

Exemplary methods performed by a first network device for performing a software upgrade, include receiving, by a first init process executing on a first root file system, an indication to perform an in-service software upgrade (ISSU). The methods further include releasing, by the first init process in response to receiving the indication to perform the ISSU, the first root file system by setting an indication that the ISSU is in progress and terminating processes executing on the first root file system. The methods further include switching, by the first init process in response to receiving the indication to perform the ISSU, from the first root file system to a second root file system by moving a root from the first root file system to the second root file system, wherein the second root file system includes an upgraded software, moving critical system files from the first root file system to the second root file system, unmounting the first root file system, and executing a second init process on the second root file system. The methods further include initializing, by the second init process executing on the second root file system, the second root file system by starting processes on the second root file system.

According to one embodiment, releasing the first root file system further comprises preventing, in response detecting the indication that the ISSU is in progress, unmounting of critical system files residing on the first root file system, thereby avoiding rebooting of a kernel.

According to one embodiment, releasing the first root file system further comprises preventing, in response detecting the indication that the ISSU is in progress, unloading of loadable kernel modules (LKMs), thereby avoiding resetting of peripheral devices connected to the first network device.

According to one embodiment, initializing the second root file system further comprises preventing, in response detecting the indication that the ISSU is in progress, mounting of critical system files on the second root file system.

According to one embodiment, initializing the second root file system further comprises preventing, in response detecting the indication that the ISSU is in progress, loading of loadable kernel modules (LKMs).

According to one embodiment, initializing the second root file system further comprises preventing, in response detecting the indication that the ISSU is in progress, resetting of hardware devices connected to the first network device.

According to one embodiment, releasing the first root file system further comprises executing a halt script, and wherein the halt script is configured to, in response detecting the indication that the ISSU is in progress, prevent unmounting of critical system files residing on the first root file system.

According to one embodiment, releasing the first root file system further comprises executing a halt script, and wherein the halt script is configured to, in response detecting the indication that the ISSU is in progress, prevent unloading of loadable kernel modules (LKMs).

According to one embodiment, initializing the second root file system further comprises executing an init script, and wherein the init script is configured to, in response detecting the indication that the ISSU is in progress, prevent mounting of critical system files on the second root file system.

According to one embodiment, initializing the second root file system further comprises executing an init script, and wherein the init script is configured to, in response detecting the indication that the ISSU is in progress, prevent loading of loadable kernel modules (LKMs).

According to one embodiment, initializing the second root file system further comprises executing an init script, and wherein the init script is configured to, in response detecting the indication that the ISSU is in progress, prevent resetting of hardware devices connected to the first network device.

### BRIEF DESCRIPTION OF THE DRAWINGS

The invention may best be understood by referring to the following description and accompanying drawings that are used to illustrate embodiments of the invention. In the drawings:

FIG. 1 is a block diagram illustrating a network according to one embodiment.

FIG. 2 is a block diagram illustrating a pseudo code for an init process according to one embodiment.

FIG. 3 is a block diagram illustrating a pseudo code for an init script according to one embodiment.

FIG. 4 is a block diagram illustrating a pseudo code for a halt script according to one embodiment.

FIG. 5A is a block diagram illustrating a network device for performing ISSU according to one embodiment.

FIG. 5B is a block diagram illustrating a network device for performing ISSU according to one embodiment.

FIG. 5C is a block diagram illustrating a network device for performing ISSU according to one embodiment.

FIG. 5D is a block diagram illustrating a network device for performing ISSU according to one embodiment.

FIG. 6 is a flow diagram illustrating a method for performing ISSU according to one embodiment.

FIG. 7A illustrates connectivity between network devices (NDs) within an exemplary network, as well as three exemplary implementations of the NDs, according to some embodiments of the invention.

FIG. 7B illustrates an exemplary way to implement a special-purpose network device according to some embodiments of the invention.

FIG. 7C illustrates various exemplary ways in which virtual network elements (VNEs) may be coupled according to some embodiments of the invention.

FIG. 7D illustrates a network with a single network element (NE) on each of the NDs, and within this straight forward approach contrasts a traditional distributed approach (commonly used by traditional routers) with a centralized approach for maintaining reachability and forwarding information (also called network control), according to some embodiments of the invention.

FIG. 7E illustrates the simple case of where each of the NDs implements a single NE, but a centralized control plane has abstracted multiple of the NEs in different NDs into (to represent) a single NE in one of the virtual network(s), according to some embodiments of the invention.

FIG. 7F illustrates a case where multiple VNEs are implemented on different NDs and are coupled to each other, and where a centralized control plane has abstracted these multiple VNEs such that they appear as a single VNE within one of the virtual networks, according to some embodiments of the invention.

FIG. 8 illustrates a general purpose control plane device with centralized control plane (CCP) software, according to some embodiments of the invention.

### DESCRIPTION OF EMBODIMENTS

The following description describes methods and apparatus for performing in-service software upgrade (ISSU). In the following description, numerous specific details such as logic implementations, opcodes, means to specify operands, resource partitioning/sharing/duplication implementations, types and interrelationships of system components, and logic partitioning/integration choices are set forth in order to provide a more thorough understanding of the present invention. It will be appreciated, however, by one skilled in the art that the invention may be practiced without such specific details. In other instances, control structures, gate level circuits and full software instruction sequences have not been shown in detail in order not to obscure the invention. Those of ordinary skill in the art, with the included descriptions, will be able to implement appropriate functionality without undue experimentation.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Bracketed text and blocks with dashed borders (e.g., large dashes, small dashes, dot-dash, and dots) may be used herein to illustrate optional operations that add additional features to embodiments of the invention. However, such notation should not be taken to mean that these are the only options or optional operations, and/or that blocks with solid borders are not optional in certain embodiments of the invention.

In the following description and claims, the terms “coupled” and “connected,” along with their derivatives, may be used. It should be understood that these terms are not intended as synonyms for each other. “Coupled” is used to indicate that two or more elements, which may or may not be in direct physical or electrical contact with each other, co-operate or interact with each other. “Connected” is used to indicate the establishment of communication between two or more elements that are coupled with each other.

An electronic device stores and transmits (internally and/or with other electronic devices over a network) code (which is composed of software instructions and which is sometimes referred to as computer program code or a computer program) and/or data using machine-readable media (also called computer-readable media), such as machine-readable storage media (e.g., magnetic disks, optical disks, read only memory (ROM), flash memory devices, phase change memory) and machine-readable transmission media (also called a carrier) (e.g., electrical, optical, radio, acoustical or other form of propagated signals—such as carrier waves, infrared signals). Thus, an electronic device (e.g., a computer) includes hardware and software, such as a set of one or more processors coupled to one or more machine-readable storage media to store code for execution on the set of processors and/or to store data. For instance, an electronic device may include non-volatile memory containing the code since the non-volatile memory can persist code/data even when the electronic device is turned off (when power is removed), and while the electronic device is turned on that part of the code that is to be executed by the processor(s) of that electronic device is typically copied from the slower non-volatile memory into volatile memory (e.g., dynamic random access memory (DRAM), static random access memory (SRAM)) of that electronic device. Typical electronic devices also include a set or one or more physical network interface(s) to establish network connections (to transmit and/or receive code and/or data using propagating signals) with other electronic devices. One or more parts of an embodiment of the invention may be implemented using different combinations of software, firmware, and/or hardware.

A network device (ND) is an electronic device that communicatively interconnects other electronic devices on the network (e.g., other network devices, end-user devices). Some network devices are “multiple services network devices” that provide support for multiple networking functions (e.g., routing, bridging, switching, Layer 2 aggregation, session border control, Quality of Service, and/or subscriber management), and/or provide support for multiple application services (e.g., data, voice, and video).

Techniques for performing ISSU at a network device with a modular kernel system is described herein. According to one embodiment, in response to receiving an indication (e.g., a request, trigger, etc.) to perform ISSU, the init process executing on a current root file system (herein referred to as the current init process) of the network device sets a global variable/indication to indicate that ISSU is in progress. The current init process then performs a set of tasks as part of a halting process to release the current root file system. Conventionally, when a system shuts down, reboots, etc., it performs a series of tasks as part of a halting process, including for example, terminating processes that are running on the current root file system, unmounting critical system files residing on the current root file system, unloading loadable kernel modules (LKMs), etc. Unmounting the critical system files, however, results in the rebooting of the kernel. Further, unloading the LKMs results in resetting of peripheral devices. Rebooting the kernel and resetting the peripheral devices result in the system requiring a longer time to boot up. In the context of networking, such a longer boot up time results in a longer service interruption. In one embodiment, the current init process overcomes such limitations by invoking a halt script that is configured/adapted to, in response to determining ISSU is in progress, prevent the unmounting of the critical system files and further prevent the unloading of the LKMs. That is to say, the present halt script is adapted to intelligently distinguish between a normal bring down (e.g., shutdown, reboot, etc.) of the network device (in which case all conventional tasks associated with a system bring down are executed) and an ISSU (in which case conventional tasks associated with a system bring down are executed, with the exception of those related to the unmounting of the critical system files and unloading of the LKMs).

According to one embodiment, the current init process then moves the root from the current root file system to a new root file system, and further moves the critical system files from the current root file system to the new root file system. The current init process then moves itself to the new root file system, and starts an init process on the new root file system (herein referred to as the new init process). Throughout the description, references are made to a “root” and “root file system”. A “root”, as used herein, is the top most directory of the operating system (typically represented as “/”). A “root file system”, as used herein, is the base file system of the root, on which other file systems/devices, etc., are mounted.

According to one embodiment, the new init process initializes the new root file system. Conventionally, when a system boots up, it performs a series of tasks as part of an initialization process, including for example, starting processes on the new root file system, mounting critical system files, loading the LKMs, resetting the hardware devices, etc. This poses a problem for ISSU because the critical system files have already been moved from the current root file system to the new root file system, and mounting these critical system files are unnecessary and would only unnecessarily increase the service interruption time. Further, unlike a normal bootup process, the LKMs are already loaded (because the halt script intelligently prevented them from being unloaded), and reloading the LKMs is unnecessary and would only unnecessarily increase the service interruption. It should be further noted that reloading the LKMs also causes the resetting of the hardware devices, thus further increasing the service interruption. Moreover, resetting the hardware devices also increases the duration of service interruption. In one embodiment, the new init process overcomes such limitations by invoking an init script that is configured/adapted to, in response to determining the ISSU is in progress, prevent the mounting of the critical system files, prevent the loading of the LKMs, and further prevent the resetting of hardware devices. That is to say, the present init script is adapted to intelligently distinguish between a normal bootup of the network device (in which case all conventional tasks associated with a system bootup are executed) and an ISSU (in which case conventional tasks associated with a system bootup are executed, with the exception of those related to the mounting of the critical system files, loading of the LKMs, and resetting the hardware devices).

Throughout the description, references are made to the current root file system and the new root file system. As used herein, the “current” root file system refers to the system that the network device is currently using prior to the ISSU, and the “new” root file system refers to the root file system that the network device migrates to as part of the ISSU. Thus, as part of the ISSU, the network device migrates/switches from the current root file system to the new root file system.

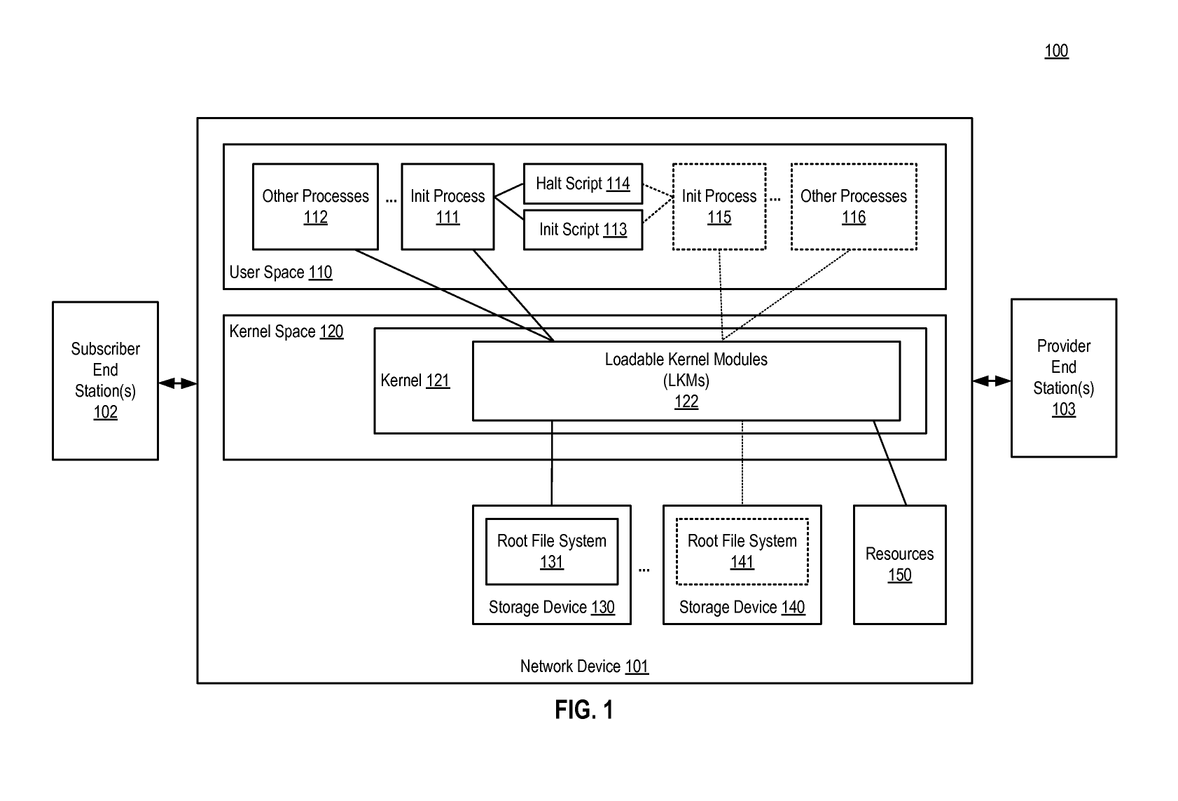

FIG. 1 is a block diagram illustrating a network according to one embodiment. In the illustrated example, network 100 includes, but is not limited to, one or more subscriber end stations 102. Examples of suitable subscriber end stations include, but are not limited to, servers, workstations, laptops, netbooks, palm tops, mobile phones, smartphones, multimedia phones, tablets, phablets, Voice Over Internet Protocol (VOIP) phones, user equipment, terminals, portable media players, GPS units, gaming systems, set-top boxes, and combinations thereof. Subscriber end stations 102 access content/services provided over the Internet and/or content/services provided on virtual private networks (VPNs) overlaid on (e.g., tunneled through) the Internet. The content and/or services are typically provided by one or more provider end stations 103 (e.g., server end stations) belonging to a service or content provider. Examples of such content and/or services include, but are not limited to, public webpages (e.g., free content, store fronts, search services), private webpages (e.g., username/password accessed webpages providing email services), and/or corporate networks over VPNs, etc.

As illustrated, subscriber end stations 102 and provider end station(s) 103 are communicatively coupled to network device 101, which can be implemented as part of a provider edge network, a core network, or any other network. In some cases, network device 101 may host on the order of thousands to millions of wire line type and/or wireless subscriber end stations, although the scope of the invention is not limited to any known number. Subscriber end stations 102 may transmit upstream packets toward provider end stations 103. Provider end stations 103 may transmit downstream packets toward subscriber end stations 102. Such upstream packets and/or downstream packets may traverse network device 101.

Network device 101 includes user space 110 and kernel space 120. An operating system typically segregates virtual memory into kernel space and user space. Primarily, the separation of the virtual memory into kernel space and user space serves to protect data and functionality from faults (by improving fault tolerance) and malicious behavior (by providing computer security). The kernel space is strictly reserved for running a privileged operating system kernel, kernel extensions, and most device drivers. In contrast, the user space is the memory area where application software and some drivers execute.

In the illustrated embodiment, kernel space 120 includes kernel 121. A kernel is a computer program that manages input/output (I/O) requests from software, and translates them into data processing instructions for the central processing unit (CPU) and other hardware devices on the system. The critical code of the kernel is usually loaded into a protected area of memory, which prevents it from being overwritten by other, less frequently used parts of the operating system or by applications. The kernel performs its tasks, such as executing user space processes (e.g., init process 111 and other processes 112) and handling interrupts, in the kernel space, whereas everything a user normally does, such as writing text in a text editor or running programs in a graphical user interface (GUI), is done in the user space. This separation is made in order to prevent user data and kernel data from interfering with each other and thereby diminishing performance or causing the system to become unstable (and possibly crashing).

According to one embodiment, kernel 121 is a modular kernel system. In a modular kernel system, some part of the system core will be located in independent files called loadable kernel modules (LKMs) that can be added to the system at run time. In the illustrated embodiment, kernel 121 comprises LKMs 122. A LKM, in other words, is an object file that contains code to extend the running kernel (e.g., kernel 121) of an operating system. LKMs are typically used to add support for new hardware and/or file systems, and/or for adding system calls. When the functionality provided by a LKM is no longer required, the LKM can be unloaded in order to free (i.e., de-allocate) resources that are assigned to it. For example, a LKM can be a device driver. In such a case, when the device driver is no longer needed, the LKM can be unloaded in order to reclaim its resources. Unloading LKMs, however, causes the peripheral devices associated with the LKMs to be reset. This is problematic for ISSU because it extends the service interruption time. Embodiments of the present invention overcome such limitations by preventing the unloading of LKMs during ISSU.

User space 110 includes init process 111, which is the first process to be started when network device 101 boots up. Init process 111 is a daemon process that continues running while network device 101 is operational. Init process 111 is configured to invoke init script 113 to perform the initialization process, including for example, starting other processes 112, which may cause resources 150 to be allocated. Depending on the type of processes that are started, resources 150 can be software, hardware, or any combination thereof. For example, resources 150 can be System V interprocess communication (IPC) resources (e.g., shared memories, semaphores, messages, sockets, etc.). Init process 111 is also configured to invoke halt script 114 to perform the halting process, including for example, terminating other processes 112 and de-allocating resources 150.

According to one embodiment, init process 111 is to invoke halt script 114 as part of a normal halting process. As used herein, a “normal halting process” refers to the halting process that is performed during a system restart/shutdown. In one embodiment, init process 111 is further configured to invoke halt script 114 as part of an ISSU halting process. As used herein, an “ISSU halting process” refers the halting process that is performed by network device 101 during ISSU. The normal halting process is not optimized for ISSU, for example, because it involves: 1) unmounting of the critical system files (which causes the rebooting of kernel 121) and 2) unloading of LKMs 122 (which causes the resetting of peripheral devices associated with the LKMs). Rebooting kernel 121 and resetting the peripheral devices result in a longer service interruption.

Embodiments of the present invention overcome such limitations by providing an intelligent halting process that is able to distinguish between a normal halting process and an ISSU halting process. More specifically, in response to determining the halting process is performed as part of an ISSU, embodiments of the present invention: 1) prevent the unmounting of the critical system files, 2) prevent the unloading of the LKMs, 3) move the root from the current root file system to a new root file system, and 4) move critical system files from the current root file system to the new root file system, thereby minimizing the service interruption. In one such embodiment, network device 114 is to invoke an intelligent halt script, such as halt script 114, that is able to distinguish between a normal halting process and an ISSU halting process, and in response to determining the halting process is being performed as part of an ISSU, the intelligent halt script is adapted to perform the operations that are specific to ISSU described above.

According to one embodiment, init process 111 is to invoke init script 113 as part of a normal initialization process. As used herein, a “normal initialization process” refers to the initialization process that is performed by network device 101 during a restart/startup process. In one embodiment, init process 111 is further configured to invoke init script 113 as part of an ISSU initialization process. As used herein, an “ISSU initialization process” refers the initialization process that is performed by network device 101 during ISSU. The normal initialization process is not optimized for ISSU, for example, because it involves: 1) the unnecessary mounting of the critical system files (because unlike a normal halting process, the ISSU halting process of the present invention includes moving the critical system files to the new root file system), 2) the unnecessary loading of the LKMs (because unlike a normal halting process, the ISSU halting process of the present invention prevents the unloading of the LKMs), and 3) the resetting of hardware devices (e.g., CPUs, memories, etc.). Performing the unnecessary mounting of the critical system files and the unnecessary loading of the LKMs result in a longer service interruption. Resetting of the hardware devices also attribute to the longer service interruption.

Embodiments of the present invention overcome such limitations by providing an intelligent initialization process that is able to distinguish between a normal initialization process and an ISSU initialization process. More specifically, in response to determining the initialization process is performed as part of an ISSU, embodiments of the present invention: 1) prevent the unnecessary mounting of the critical system files, 2) prevent the unnecessary loading of the LKMs, 3) prevent the resetting of the hardware devices, and 4) unmount the current root file system after the root has been moved to the new root file system, thereby reducing the service interruption time. In one such embodiment, network device 114 is to invoke an intelligent init script, such as init script 113, that is able to distinguish between a normal initialization process and an ISSU initialization process, and in response to determining the initialization process is being performed as part of an ISSU, the intelligent init script is adapted to perform the operations that are specific to ISSU as described above.

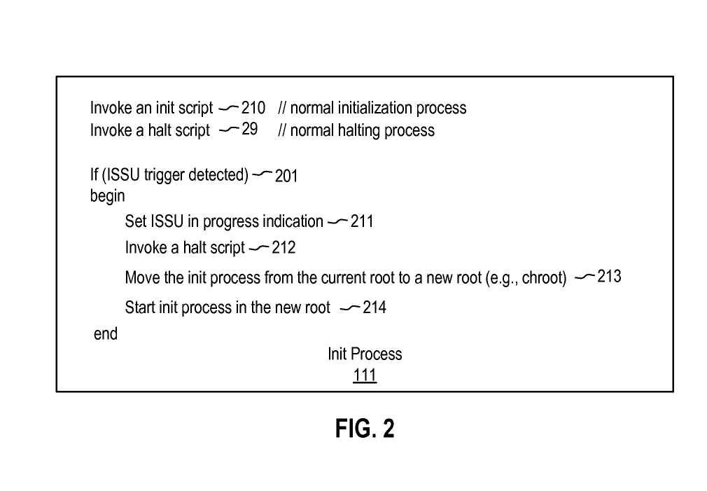

FIG. 2 is a block diagram illustrating a pseudo code for an init process according to one embodiment. For example, the pseudo code may represent the code of an executable binary of init process 111. In the illustrated pseudo code, init process 111 is adapted to invoke an init script (e.g., init script 113) as part of operation 210 during a normal initialization process. Init process 111 is further adapted to invoke a halt script (e.g., halt script 113) as part of operation 209 during a normal halting process. Unlike a conventional normal init process, however, init process 111 is further adapted to perform specific operations during an ISSU in order to minimize the service interruption. According to one embodiment, in response to detecting an ISSU trigger (i.e., a request to perform ISSU) at operation 201, init process 111 is adapted to perform operations 211-214.

At operation 211, init process 111 sets an ISSU in progress indication. For example, this indication can be a global variable that is accessible by all processes and/or scripts that are executed by init process 111. At operation 212, init process 111 invokes/executes a halt script (e.g., halt script 114). At operation 213, init process 111 moves the init process from the current root (e.g., a root directory of root file system 131) to a new root (e.g., a root directory of root file system 141). For example, as part of operation 213 init process 111 may perform an operation similar to the Unix-based “chroot” operation, which changes the apparent root directory of the current running process and its children. At operation 214, init process 111 starts a new init process in the new root, for example, by executing the init process executable in the new root.

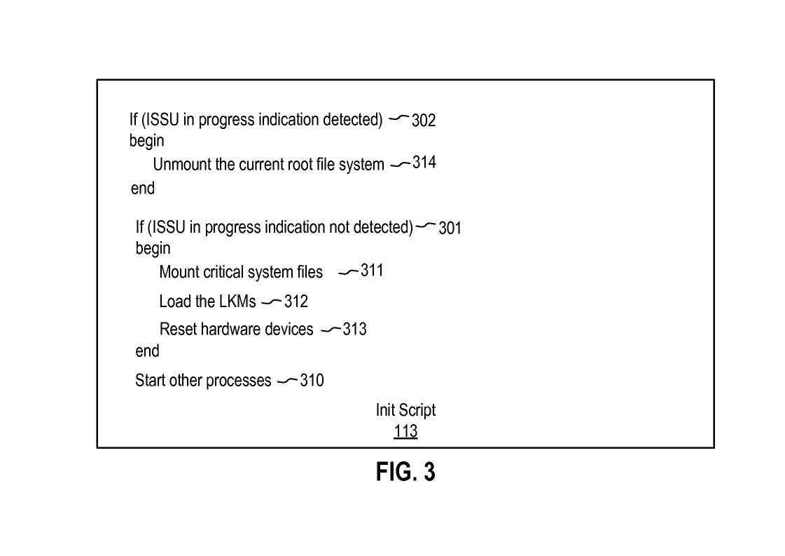

FIG. 3 is a block diagram illustrating a pseudo code for an init script according to one embodiment. In one embodiment, in response to determining ISSU is in progress at operation 302, init script 113 is adapted to unmount the current root file system at operation 314. According to one embodiment, in response to determining that ISSU is not in progress at operation 301, init script 113 performs operations 311-313 as part of a normal initialization process. At operation 311, init script 113 mounts critical system files (e.g., /dev, /sys, /proc, etc.) on the root file system. At operation 312, init script 113 loads the LKMs (e.g, LKMs 122). At operation 313, init script 113 performs hardware resets (e.g., by resetting memories, CPU(s), etc.).

Init script 113 is further adapted to perform specific operations during an ISSU in order to minimize the service interruption. Returning now back to operation 301. According to one embodiment, in response to determining ISSU is in progress, init script 113 is adapted to prevent operations 311-313 from being performed. For example, in response to detecting the indication that ISSU is in progress at operation 301, init script 113 prevents: 1) the mounting of the critical system files, 2) the loading of the LKMs, and 3) the resetting of hardware devices. By preventing operations 311-313 from being performed, init script 113 helps to minimize the service interruption.

As part of the normal initialization process, init script 113 is adapted to start other processes (e.g., other processes 112) at operation 310. According to one embodiment, init script 113 is to start other processes after the current root file system (i.e., the root file system from which the network device is migrating away from as part of the ISSU) has been unmounted in order to ensure that there are no dependencies on the kernel (e.g., kernel 121) before starting the new processes on the new root file system.

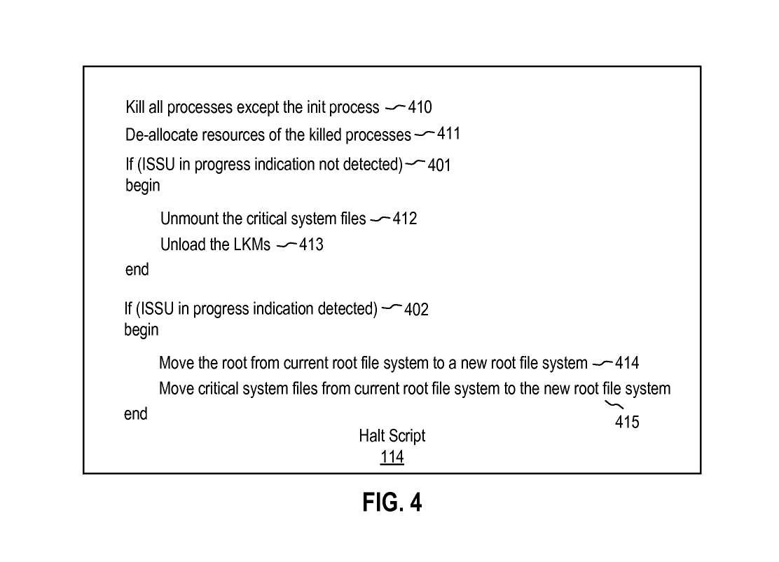

FIG. 4 is a block diagram illustrating a pseudo code for a halt script according to one embodiment. As part of the normal halting process, halt script 114 is adapted to kill (i.e., terminate) all processes (e.g., other processes 112) except for the init process (e.g., init process 111) at operation 410. For example, as part of operation 410, halt script 114 may perform operations similar to the Unix-based operations “sigterm” and “sigkill”. Halt script 114 is further configured to de-allocate resources (e.g., resources 150) of terminated user space processes at operation 411. For example, as part of operation 411, halt script 114 de-allocates System V interprocess communication (IPC) resources (e.g., shared memories, semaphores, messages, sockets, etc.) associated with the terminated user space processes. According to one embodiment, in response to determining that ISSU is not in progress at operation 401, halt script 114 performs operations 412-413 as part of the normal halting process. For example, halt script 114 unmounts the critical system files at operation 412 and unloads the LKMs at operation 413.

Halt script 114 is further adapted to perform specific operations during an ISSU in order to minimize the service interruption. Returning now back to operation 401, according to one embodiment, in response to determining ISSU is in progress, halt script 114 is adapted to prevent operations 412-413 from being performed. For example, in response to detecting the indication that ISSU is in progress at operation 401, halt script 114 prevents: 1) the unmounting of the critical system files, and 2) the unloading of the LKMs. Preventing the unmounting of the critical system files prevents the rebooting of the kernel (e.g., kernel 121) and minimizes the service interruption. Preventing the unloading of the LKMs prevents the resetting of peripheral devices (e.g., monitor, keyboard, mouse, network interfaces, etc.) and allows them to continue operating in a headless mode, and further minimizes the service interruption. According to one embodiment, in response to determining ISSU is in progress at operation 402, halt script 114 is adapted to: 1) move the root from the current root file system to a new root file system at operation 414 (e.g., by using an operation similar to the Unix-based “pivot_root” operation, and 2) move the critical system files from the current root file system to the new root file system at operation 415 (e.g., by using an operation similar to the Unix-based “mount—move” operation. It should be noted that by performing operation 415 to move the critical system files to the new root file system device instead of performing operation 412 to unmount the critical system files at operation, halt script 114 is able to prevent the rebooting of the kernel, and thus minimize the service interruption.

Each of init script 113 and halt script 114 is illustrated as one file. One having ordinary skill in the art would recognize that init script 113 and/or halt script 114 can each be implemented as multiple files. Further, it should be understood that init script 113 and/or halt script 114 can include more or less operations than those illustrated without departing from the broader scope and spirit of the present invention. Further, it should be understood that init script 113 and halt script 114 can be implemented as one file. In one embodiment, some or all of the operations of init script 113 and/or halt script 114 can also be implemented as part of init process 111. In yet another embodiment, some of the operations performed by init process 111 can be implemented as part of init script 113 and/or halt script 114.

In order to better illustrate the intelligent halting and initialization processes of the present invention, the normal halting process and the normal initialization process shall now be described by way of example. Referring now to FIG. 2, in response to detecting a trigger to shutdown/restart, at operation 29 init process 111 invokes halt script 114 as part of the normal halting process. Referring now to FIG. 4, at operation 410 halt script 114 terminates other processes 112 without terminating init process 111. At operation 411, halt script 114 de-allocates some or all of resources 150 associated with the terminated processes. At operation 401, in response to determining that ISSU is not in progress, halt script 114 unmounts the critical system files at operation 412 and unloads LKMs 122 at operation 413.

Returning now back to FIG. 2, at operation 210, during a normal bootup (e.g., from a restart/shutdown process), init process 111 invokes init script 113 as part of the normal initialization process. Referring now to FIG. 3, at operation 301, in response to determining ISSU is not in progress, init script 113 mounts critical system files at operation 311, loads LKMs 122 at operation 112, and resets hardware devices at operation 313. Init script 113 then starts other processes 112 at operation 310, causing resources 150 to be allocated.

The ISSU halting process and the ISSU initialization process according to one embodiment shall now be described. Assume that the root of network device 101 is currently mapped to root file system 131 stored as part of storage device 130. Assume further that a new software version has been installed on root file system 141 stored as part of storage device 140. As will be described below, after the ISSU is completed, new processes will started in root file system 141 which are spawned off of the new software. Referring now to FIG. 2, at operation 201 init process 111 detects an indication to perform an ISSU (e.g., from an administrator via a command line interface (CLI), from a remote host, etc.). In response, init process 111 sets a global variable to indicate that ISSU is in progress at operation 211, and invokes halt script 114 at operation 212.

Referring now to FIG. 4, at operation 410 halt script 114 terminates other processes 112 without terminating init process 111. At operation 411, halt script 114 de-allocates some or all of resources 150 of the terminated processes. At operation 401, in response to determining that ISSU is in progress, halt script 114 prevents the unmounting of the critical system files (operation 412) and further prevents the unloading of LKMs 122 (operation 413). At operation 402, halt script 114 determines that ISSU is in progress. In response to determining ISSU is in progress, halt script 114 moves the root from the current root file system (i.e., root file system 131) to the new root file system (i.e., root file system 141) at operation 414, and further moves the critical system files from the current root file system to the new root file system at operation 415.

Referring now back to FIG. 2, at operation 213 init process 111 then moves the current init process (i.e., init process 111) from root file system 131 to root file system 141, and starts new init process 115 in the new root. New init process 115 performs operations similar to those described in FIG. 2. For example, init process 215 invokes init script 113 at operation 210 to perform the initialization process. Referring now to FIG. 3, at operation 302 init script 113 determines that ISSU is in progress and unmounts the current root file system (i.e., root file system 131) at operation 314.

At operation 301, in response to determining that ISSU is in progress, init script 113 prevents the unnecessary: 1) mounting of the critical system files (operation 311), 2) loading of LKMs 122 (operation 312), and 3) resetting of hardware devices (operation 313). At operation 310, init script 113 starts other processes 116. In one embodiment, init script 113 starts other processes after the current root file system (i.e., root file system 131) has been unmounted in order to ensure that there are no dependencies on kernel 121 before starting the new other processes 116.

It should be noted that although root file systems 131 and 141 are illustrated as being stored in separate storage devices, one having ordinary skill in the art would recognize that root file systems 131 and 141 can also be stored as part of logical partitions of a single storage device. It should be further noted that storage devices 130 and 140 need not be physically included as part of network device 101. For example, storage devices 130 and 140 can be remote devices that are communicatively coupled to network device 101. Various embodiments of the present mechanisms for performing ISSU shall now be described in greater details through the discussion of various other figures below.

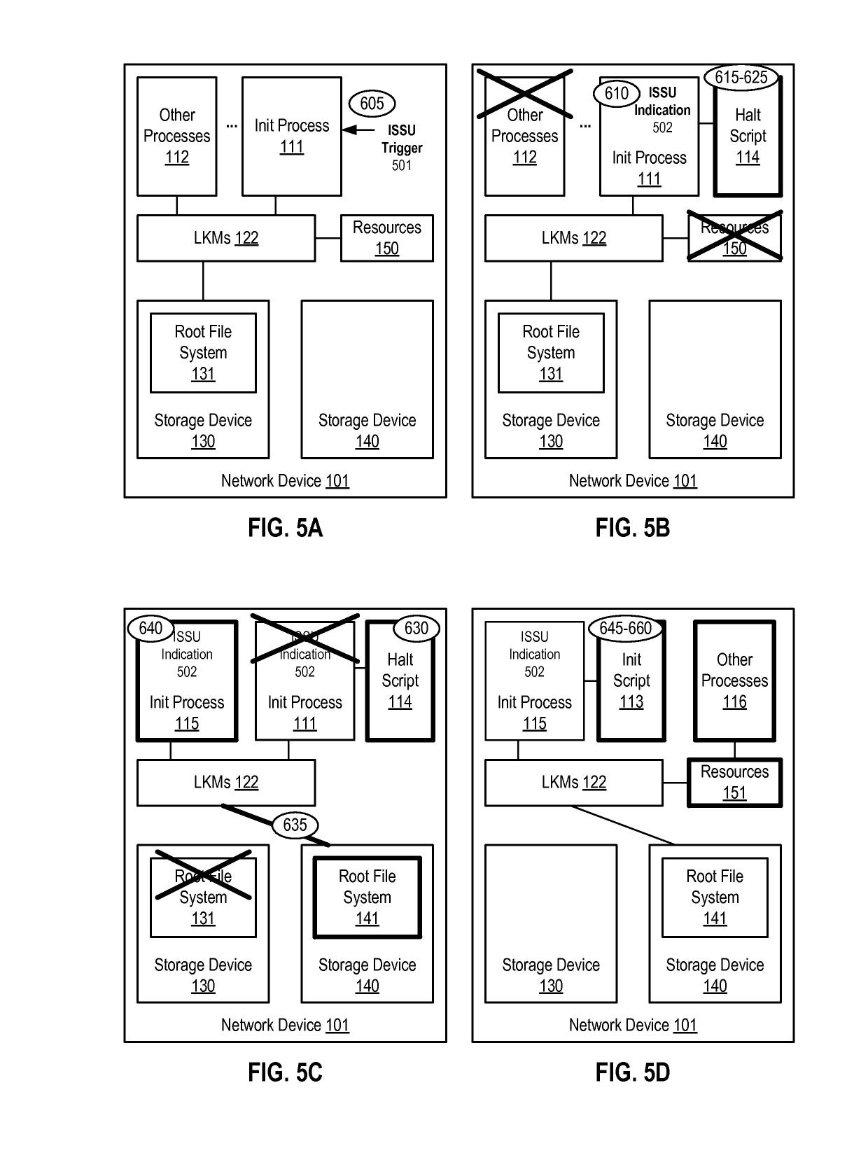

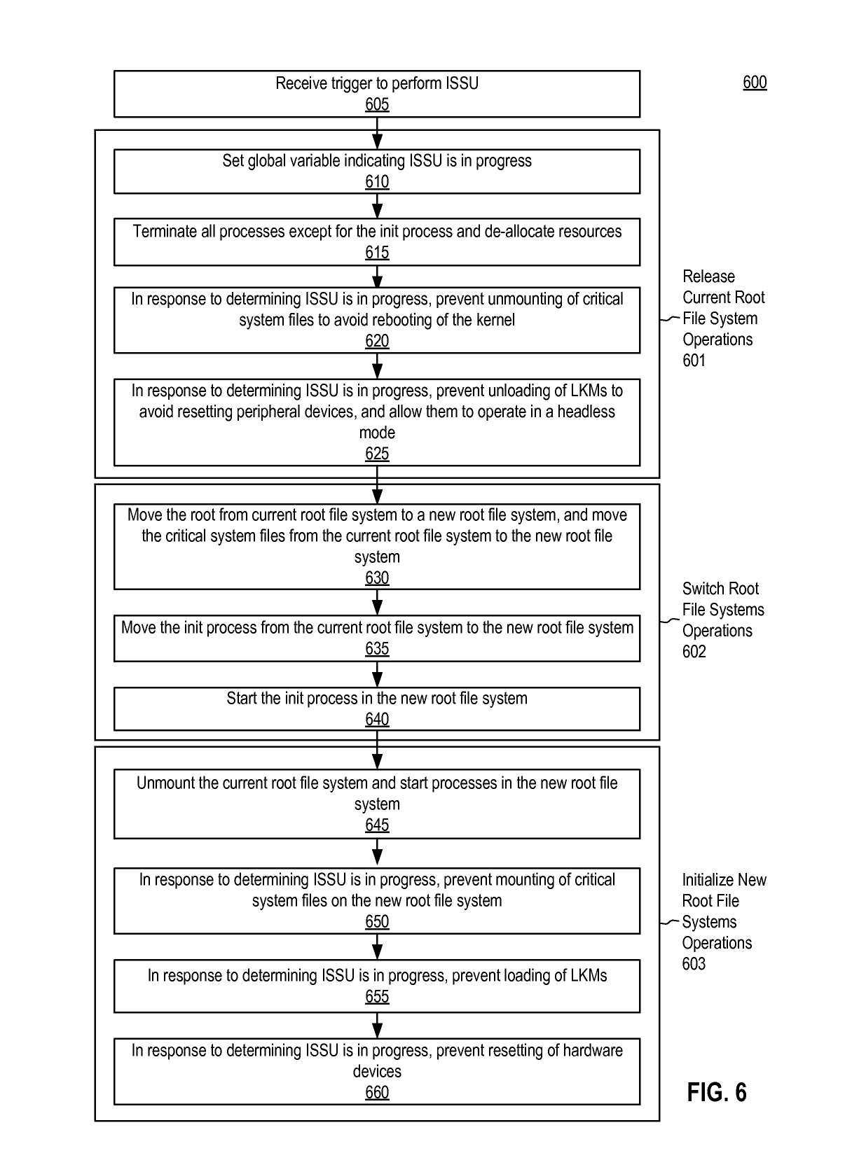

FIGS. 5A-5D are block diagrams illustrating a network device for performing ISSU according to one embodiment. Network device 101 of FIGS. 5A-5D is similar to network device 101 of FIG. 1. For the sake of brevity, the various components of network device 101 shall not be described herein. Further, certain details of network device 101 have been omitted in FIGS. 5A-5D in order to avoid obscuring the invention. FIGS. 5A-5D illustrate an example of ISSU as performed by embodiments of the present invention. FIGS. 5A-5D shall be described in conjunction with FIG. 6.

FIG. 6 is a flow diagram illustrating a method for performing ISSU according to one embodiment. For example, method 600 can be performed by one or more init processes, such as init processes 111 and 115 of network device 101. Method 600 can be implemented in software, firmware, hardware, or any combination thereof. Method 600 comprises of release current root file system operations 601, switch root file systems operations 602, and initialize new root file systems operations 603. In one embodiment, release current root file system operations 601 and switch root file systems 602 can be performed by a current init process (e.g., init process 111) executing on a current root file system (e.g., root file system 131), and initialize new root file systems operations 603 can be performed by a new init process (e.g., init process 115) executing on a new root file system (e.g., root file system 141).

The operations in this and other flow diagrams will be described with reference to the exemplary embodiments of the other figures. However, it should be understood that the operations of the flow diagrams can be performed by embodiments of the invention other than those discussed with reference to the other figures, and the embodiments of the invention discussed with reference to these other figures can perform operations different than those discussed with reference to the flow diagrams.

Referring now to FIG. 6, at block 605, a current init process receives a trigger to perform ISSU. At block 610 the current init process sets a global variable indicating ISSU is in progress. At block 615, the current init process terminates all processes (except for the init process itself) running on the current root. The current init process further de-allocates resources that were allocated to the terminated processes. At block 620, the current init process, in response to determining ISSU is in progress, prevents the unmounting of critical system files to avoid rebooting of the kernel. At block 625, the current init process, in response to determining ISSU is in progress, prevents the unloading of LKMs to avoid resetting the peripheral devices, and allow them to operate in a headless mode.

For example, referring now to FIG. 5A, init process 111 receives ISSU trigger 501 to perform ISSU. Referring now to FIG. 5B, init process 111 sets ISSU indication 502 (e.g., as part of its operation 211), and executes halt script 114 (e.g., as part of its operation 212). Halt script 114 terminates other processes 112 without terminating init process 111 at its operation 410. Halt script 114 further de-allocates resources 150 at operation 411. Halt script 114 determines that ISSU is in progress at operation 401 (e.g., by detecting ISSU indication 502). In response to determining ISSU is in progress, halt script 114 prevents the unmounting of the critical system files (operation 412), and prevents the unloading of LKMs 122 (operation 413). Thus, in contrast to a normal halting process, halt script 114 prevents the kernel from being rebooted, and the peripheral devices from being reset, by preventing the unmounting of the critical system files and the unloading of the LKM, respectively.

Referring now back to FIG. 6, at block 630, the current init process moves the root from the current root file system to a new root file system, and further moves the critical system files from the current root file system to the new root file system. At block 635, the current init process moves the init process (i.e., itself) from the current root file system to the new root file system. At block 640, the current init process starts a new init process in the new root file system.

For example, referring now to FIG. 5C, halt script 114 moves the root from root file system 131 to root file system 141 at operation 414 (see FIG. 4). Further, halt script 114 moves the critical system files from root file system 131 to root file system 141 at operation 415. After halt script 114 is completed, init process 111 proceeds to its operation 213 (see FIG. 2) and moves the init process (i.e., itself) from root file system 131 to root file system 141. At operation 214, init process 111 starts a new init process 115 in the new root file system 141.

Referring now back to FIG. 6, at block 645 the new init process unmounts the current root file system and starts other processes in the new root file system, causing resources to be allocated. At block 650, the new init process, in response to determining ISSU is in progress, prevents the mounting of critical system files on the new root file system. At block 655, in response to determining ISSU is in progress, the new init process prevents the loading of LKMs. At block 660, in response to determining ISSU is in progress, the new init process prevents the resetting of hardware devices.

For example, referring now to FIG. 5D, init process 115 invokes init script 113. Init script determines that ISSU is in progress at operation 302 (see FIG. 3) and unmounts the current root file system (i.e., root file system 131) at operation 314. At operation 301, init script 113 determines that ISSU is in progress. At operation 301, init script 113 determines that ISSU is in progress and prevents: 1) the mounting of critical system files (operation 311), 2) the loading of LKMs 122 (operation 312), and 3) the resetting of hardware devices (operation 313). At operation 310, init script 113 starts other processes 116, causing resources 151 to be allocated. It should be noted that init process 111 and other processes 116 which are started in root file system 141 are spawned off the upgraded software. Thus, at the end of the ISSU process, network device 101 is operating under the new software.

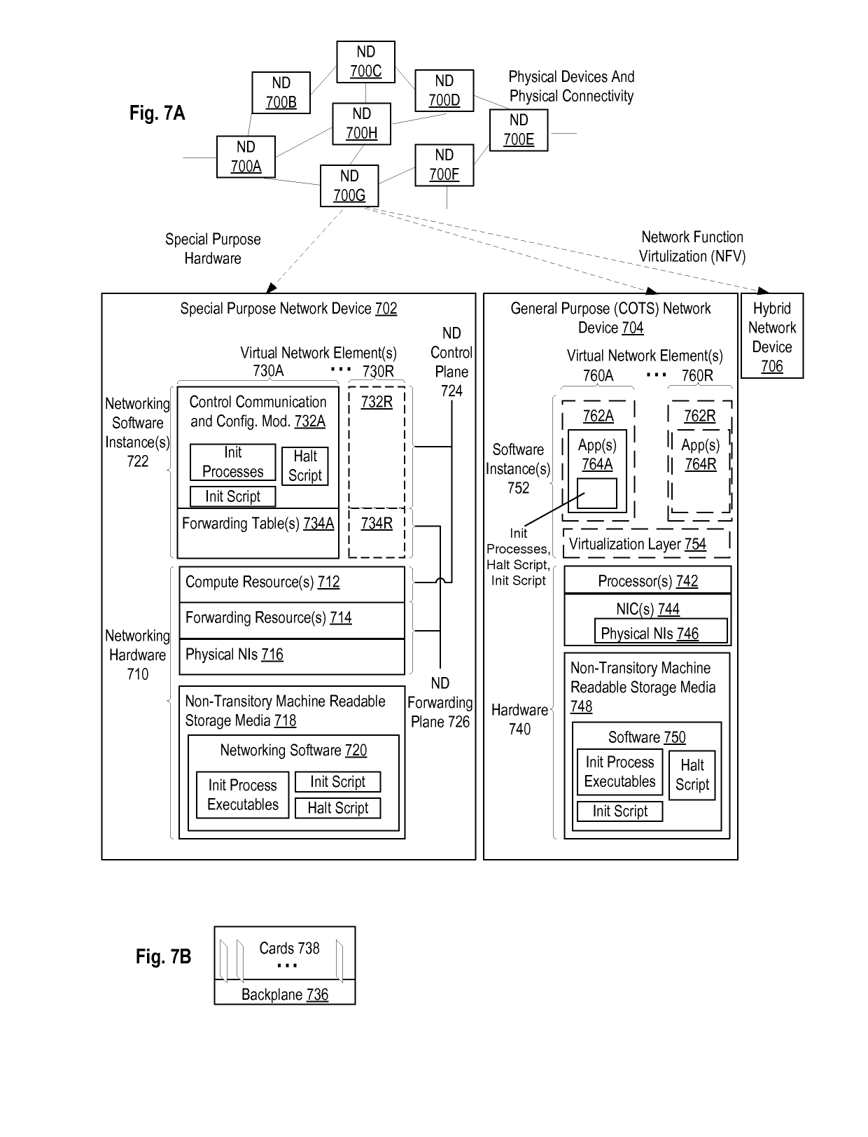

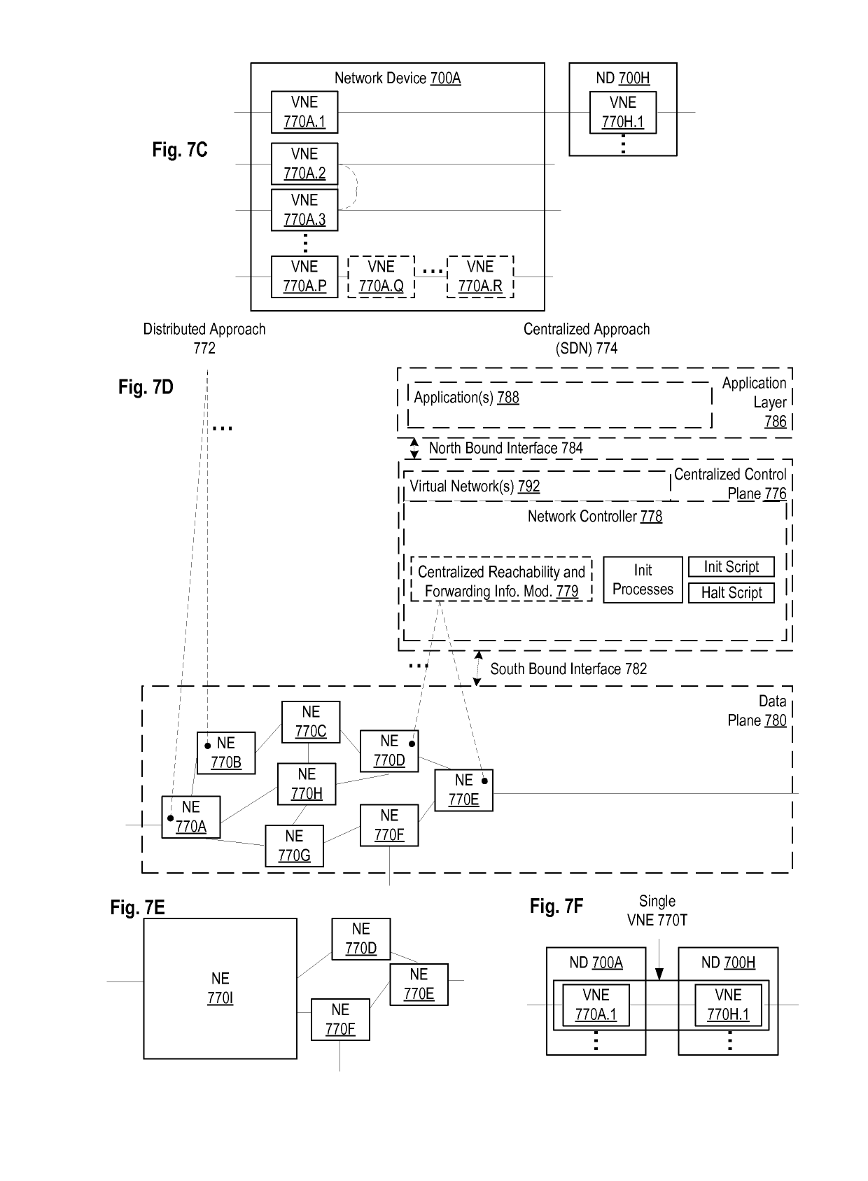

FIG. 7A illustrates connectivity between network devices (NDs) within an exemplary network, as well as three exemplary implementations of the NDs, according to some embodiments of the invention. FIG. 7A shows NDs 700A-H, and their connectivity by way of lines between A-B, B-C, C-D, D-E, E-F, F-G, and A-G, as well as between H and each of A, C, D, and G. These NDs are physical devices, and the connectivity between these NDs can be wireless or wired (often referred to as a link). An additional line extending from NDs 700A, E, and F illustrates that these NDs act as ingress and egress points for the network (and thus, these NDs are sometimes referred to as edge NDs; while the other NDs may be called core NDs).

Two of the exemplary ND implementations in FIG. 7A are: 1) a special-purpose network device 702 that uses custom application—specific integrated—circuits (ASICs) and a proprietary operating system (OS); and 2) a general purpose network device 704 that uses common off-the-shelf (COTS) processors and a standard OS.

The special-purpose network device 702 includes networking hardware 710 comprising compute resource(s) 712 (which typically include a set of one or more processors), forwarding resource(s) 714 (which typically include one or more ASICs and/or network processors), and physical network interfaces (NIs) 716 (sometimes called physical ports), as well as non-transitory machine readable storage media 718 having stored therein networking software 720. A physical NI is hardware in a ND through which a network connection (e.g., wirelessly through a wireless network interface controller (WNIC) or through plugging in a cable to a physical port connected to a network interface controller (NIC)) is made, such as those shown by the connectivity between NDs 700A-H. During operation, the networking software 720 may be executed by the networking hardware 710 to instantiate a set of one or more networking software instance(s) 722. Each of the networking software instance(s) 722, and that part of the networking hardware 710 that executes that network software instance (be it hardware dedicated to that networking software instance and/or time slices of hardware temporally shared by that networking software instance with others of the networking software instance(s) 722), form a separate virtual network element 730A-R. Each of the virtual network element(s) (VNEs) 730A-R includes a control communication and configuration module 732A-R (sometimes referred to as a local control module or control communication module) and forwarding table(s) 734A-R, such that a given virtual network element (e.g., 730A) includes the control communication and configuration module (e.g., 732A), a set of one or more forwarding table(s) (e.g., 734A), and that portion of the networking hardware 710 that executes the virtual network element (e.g., 730A).

Software 720 can include code which when executed by networking hardware 710, causes networking hardware 710 to perform operations of one or more embodiments of the present invention as part networking software instances 722.

The special-purpose network device 702 is often physically and/or logically considered to include: 1) a ND control plane 724 (sometimes referred to as a control plane) comprising the compute resource(s) 712 that execute the control communication and configuration module(s) 732A-R; and 2) a ND forwarding plane 726 (sometimes referred to as a forwarding plane, a data plane, or a media plane) comprising the forwarding resource(s) 714 that utilize the forwarding table(s) 734A-R and the physical NIs 716. By way of example, where the ND is a router (or is implementing routing functionality), the ND control plane 724 (the compute resource(s) 712 executing the control communication and configuration module(s) 732A-R) is typically responsible for participating in controlling how data (e.g., packets) is to be routed (e.g., the next hop for the data and the outgoing physical NI for that data) and storing that routing information in the forwarding table(s) 734A-R, and the ND forwarding plane 726 is responsible for receiving that data on the physical NIs 716 and forwarding that data out the appropriate ones of the physical NIs 716 based on the forwarding table(s) 734A-R.

FIG. 7B illustrates an exemplary way to implement the special-purpose network device 702 according to some embodiments of the invention. FIG. 7B shows a special-purpose network device including cards 738 (typically hot pluggable). While in some embodiments the cards 738 are of two types (one or more that operate as the ND forwarding plane 726 (sometimes called line cards), and one or more that operate to implement the ND control plane 724 (sometimes called control cards)), alternative embodiments may combine functionality onto a single card and/or include additional card types (e.g., one additional type of card is called a service card, resource card, or multi-application card). A service card can provide specialized processing (e.g., Layer 4 to Layer 7 services (e.g., firewall, Internet Protocol Security (IPsec), Secure Sockets Layer (SSL)/Transport Layer Security (TLS), Intrusion Detection System (IDS), peer-to-peer (P2P), Voice over IP (VoIP) Session Border Controller, Mobile Wireless Gateways (Gateway General Packet Radio Service (GPRS) Support Node (GGSN), Evolved Packet Core (EPC) Gateway)). By way of example, a service card may be used to terminate IPsec tunnels and execute the attendant authentication and encryption algorithms. These cards are coupled together through one or more interconnect mechanisms illustrated as backplane 736 (e.g., a first full mesh coupling the line cards and a second full mesh coupling all of the cards).

Returning to FIG. 7A, the general purpose network device 704 includes hardware 740 comprising a set of one or more processor(s) 742 (which are often COTS processors) and network interface controller(s) 744 (NICs; also known as network interface cards) (which include physical NIs 746), as well as non-transitory machine readable storage media 748 having stored therein software 750. During operation, the processor(s) 742 execute the software 750 to instantiate one or more sets of one or more applications 764A-R. While one embodiment does not implement virtualization, alternative embodiments may use different forms of virtualization—represented by a virtualization layer 754 and software containers 762A-R. For example, one such alternative embodiment implements operating system-level virtualization, in which case the virtualization layer 754 represents the kernel of an operating system (or a shim executing on a base operating system) that allows for the creation of multiple software containers 762A-R that may each be used to execute one of the sets of applications 764A-R. In this embodiment, the multiple software containers 762A-R (also called virtualization engines, virtual private servers, or jails) are each a user space instance (typically a virtual memory space); these user space instances are separate from each other and separate from the kernel space in which the operating system is run; the set of applications running in a given user space, unless explicitly allowed, cannot access the memory of the other processes. Another such alternative embodiment implements full virtualization, in which case: 1) the virtualization layer 754 represents a hypervisor (sometimes referred to as a virtual machine monitor (VMM)) or a hypervisor executing on top of a host operating system; and 2) the software containers 762A-R each represent a tightly isolated form of software container called a virtual machine that is run by the hypervisor and may include a guest operating system. A virtual machine is a software implementation of a physical machine that runs programs as if they were executing on a physical, non-virtualized machine; and applications generally do not know they are running on a virtual machine as opposed to running on a “bare metal” host electronic device, though some systems provide para-virtualization which allows an operating system or application to be aware of the presence of virtualization for optimization purposes.

The instantiation of the one or more sets of one or more applications 764A-R, as well as the virtualization layer 754 and software containers 762A-R if implemented, are collectively referred to as software instance(s) 752. Each set of applications 764A-R, corresponding software container 762A-R if implemented, and that part of the hardware 740 that executes them (be it hardware dedicated to that execution and/or time slices of hardware temporally shared by software containers 762A-R), forms a separate virtual network element(s) 760A-R.

The virtual network element(s) 760A-R perform similar functionality to the virtual network element(s) 730A-R—e.g., similar to the control communication and configuration module(s) 732A and forwarding table(s) 734A (this virtualization of the hardware 740 is sometimes referred to as network function virtualization (NFV)). Thus, NFV may be used to consolidate many network equipment types onto industry standard high volume server hardware, physical switches, and physical storage, which could be located in Data centers, NDs, and customer premise equipment (CPE). However, different embodiments of the invention may implement one or more of the software container(s) 762A-R differently. For example, while embodiments of the invention are illustrated with each software container 762A-R corresponding to one VNE 760A-R, alternative embodiments may implement this correspondence at a finer level granularity (e.g., line card virtual machines virtualize line cards, control card virtual machine virtualize control cards, etc.); it should be understood that the techniques described herein with reference to a correspondence of software containers 762A-R to VNEs also apply to embodiments where such a finer level of granularity is used.

In certain embodiments, the virtualization layer 754 includes a virtual switch that provides similar forwarding services as a physical Ethernet switch. Specifically, this virtual switch forwards traffic between software containers 762A-R and the NIC(s) 744, as well as optionally between the software containers 762A-R; in addition, this virtual switch may enforce network isolation between the VNEs 760A-R that by policy are not permitted to communicate with each other (e.g., by honoring virtual local area networks (VLANs)).

Software 750 can include code which when executed by processor(s) 742, cause processor(s) 742 to perform operations of one or more embodiments of the present invention as part software containers 762A-R.

The third exemplary ND implementation in FIG. 7A is a hybrid network device 706, which includes both custom ASICs/proprietary OS and COTS processors/standard OS in a single ND or a single card within an ND. In certain embodiments of such a hybrid network device, a platform VM (i.e., a VM that that implements the functionality of the special-purpose network device 702) could provide for para-virtualization to the networking hardware present in the hybrid network device 706.

Regardless of the above exemplary implementations of an ND, when a single one of multiple VNEs implemented by an ND is being considered (e.g., only one of the VNEs is part of a given virtual network) or where only a single VNE is currently being implemented by an ND, the shortened term network element (NE) is sometimes used to refer to that VNE. Also in all of the above exemplary implementations, each of the VNEs (e.g., VNE(s) 730A-R, VNEs 760A-R, and those in the hybrid network device 706) receives data on the physical NIs (e.g., 716, 746) and forwards that data out the appropriate ones of the physical NIs (e.g., 716, 746). For example, a VNE implementing IP router functionality forwards IP packets on the basis of some of the IP header information in the IP packet; where IP header information includes source IP address, destination IP address, source port, destination port (where “source port” and “destination port” refer herein to protocol ports, as opposed to physical ports of a ND), transport protocol (e.g., user datagram protocol (UDP), Transmission Control Protocol (TCP), and differentiated services (DSCP) values.

FIG. 7C illustrates various exemplary ways in which VNEs may be coupled according to some embodiments of the invention. FIG. 7C shows VNEs 770A.1-770A.P (and optionally VNEs 770A.Q-770A.R) implemented in ND 700A and VNE 770H.1 in ND 700H. In FIG. 7C, VNEs 770A.1-P are separate from each other in the sense that they can receive packets from outside ND 700A and forward packets outside of ND 700A; VNE 770A.1 is coupled with VNE 770H.1, and thus they communicate packets between their respective NDs; VNE 770A.2-770A.3 may optionally forward packets between themselves without forwarding them outside of the ND 700A; and VNE 770A.P may optionally be the first in a chain of VNEs that includes VNE 770A.Q followed by VNE 770A.R (this is sometimes referred to as dynamic service chaining, where each of the VNEs in the series of VNEs provides a different service—e.g., one or more layer 4-7 network services). While FIG. 7C illustrates various exemplary relationships between the VNEs, alternative embodiments may support other relationships (e.g., more/fewer VNEs, more/fewer dynamic service chains, multiple different dynamic service chains with some common VNEs and some different VNEs).

The NDs of FIG. 7A, for example, may form part of the Internet or a private network; and other electronic devices (not shown; such as end user devices including workstations, laptops, netbooks, tablets, palm tops, mobile phones, smartphones, phablets, multimedia phones, Voice Over Internet Protocol (VOIP) phones, terminals, portable media players, GPS units, wearable devices, gaming systems, set-top boxes, Internet enabled household appliances) may be coupled to the network (directly or through other networks such as access networks) to communicate over the network (e.g., the Internet or virtual private networks (VPNs) overlaid on (e.g., tunneled through) the Internet) with each other (directly or through servers) and/or access content and/or services. Such content and/or services are typically provided by one or more servers (not shown) belonging to a service/content provider or one or more end user devices (not shown) participating in a peer-to-peer (P2P) service, and may include, for example, public webpages (e.g., free content, store fronts, search services), private webpages (e.g., username/password accessed webpages providing email services), and/or corporate networks over VPNs. For instance, end user devices may be coupled (e.g., through customer premise equipment coupled to an access network (wired or wirelessly)) to edge NDs, which are coupled (e.g., through one or more core NDs) to other edge NDs, which are coupled to electronic devices acting as servers. However, through compute and storage virtualization, one or more of the electronic devices operating as the NDs in FIG. 7A may also host one or more such servers (e.g., in the case of the general purpose network device 704, one or more of the software containers 762A-R may operate as servers; the same would be true for the hybrid network device 706; in the case of the special-purpose network device 702, one or more such servers could also be run on a virtualization layer executed by the compute resource(s) 712); in which case the servers are said to be co-located with the VNEs of that ND.

A virtual network is a logical abstraction of a physical network (such as that in FIG. 7A) that provides network services (e.g., L2 and/or L3 services). A virtual network can be implemented as an overlay network (sometimes referred to as a network virtualization overlay) that provides network services (e.g., layer 2 (L2, data link layer) and/or layer 3 (L3, network layer) services) over an underlay network (e.g., an L3 network, such as an Internet Protocol (IP) network that uses tunnels (e.g., generic routing encapsulation (GRE), layer 2 tunneling protocol (L2TP), IPSec) to create the overlay network).

A network virtualization edge (NVE) sits at the edge of the underlay network and participates in implementing the network virtualization; the network-facing side of the NVE uses the underlay network to tunnel frames to and from other NVEs; the outward-facing side of the NVE sends and receives data to and from systems outside the network. A virtual network instance (VNI) is a specific instance of a virtual network on a NVE (e.g., a NE/VNE on an ND, a part of a NE/VNE on a ND where that NE/VNE is divided into multiple VNEs through emulation); one or more VNIs can be instantiated on an NVE (e.g., as different VNEs on an ND). A virtual access point (VAP) is a logical connection point on the NVE for connecting external systems to a virtual network; a VAP can be physical or virtual ports identified through logical interface identifiers (e.g., a VLAN ID).

Examples of network services include: 1) an Ethernet LAN emulation service (an Ethernet-based multipoint service similar to an Internet Engineering Task Force (IETF) Multiprotocol Label Switching (MPLS) or Ethernet VPN (EVPN) service) in which external systems are interconnected across the network by a LAN environment over the underlay network (e.g., an NVE provides separate L2 VNIs (virtual switching instances) for different such virtual networks, and L3 (e.g., IP/MPLS) tunneling encapsulation across the underlay network); and 2) a virtualized IP forwarding service (similar to IETF IP VPN (e.g., Border Gateway Protocol (BGP)/MPLS IPVPN) from a service definition perspective) in which external systems are interconnected across the network by an L3 environment over the underlay network (e.g., an NVE provides separate L3 VNIs (forwarding and routing instances) for different such virtual networks, and L3 (e.g., IP/MPLS) tunneling encapsulation across the underlay network)). Network services may also include quality of service capabilities (e.g., traffic classification marking, traffic conditioning and scheduling), security capabilities (e.g., filters to protect customer premises from network—originated attacks, to avoid malformed route announcements), and management capabilities (e.g., full detection and processing).

FIG. 7D illustrates a network with a single network element on each of the NDs of FIG. 7A, and within this straight forward approach contrasts a traditional distributed approach (commonly used by traditional routers) with a centralized approach for maintaining reachability and forwarding information (also called network control), according to some embodiments of the invention. Specifically, FIG. 7D illustrates network elements (NEs) 770A-H with the same connectivity as the NDs 700A-H of FIG. 7A.

FIG. 7D illustrates that the distributed approach 772 distributes responsibility for generating the reachability and forwarding information across the NEs 770A-H; in other words, the process of neighbor discovery and topology discovery is distributed.

For example, where the special-purpose network device 702 is used, the control communication and configuration module(s) 732A-R of the ND control plane 724 typically include a reachability and forwarding information module to implement one or more routing protocols (e.g., an exterior gateway protocol such as Border Gateway Protocol (BGP), Interior Gateway Protocol(s) (IGP) (e.g., Open Shortest Path First (OSPF), Intermediate System to Intermediate System (IS-IS), Routing Information Protocol (RIP)), Label Distribution Protocol (LDP), Resource Reservation Protocol (RSVP), as well as RSVP-Traffic Engineering (TE): Extensions to RSVP for LSP Tunnels, Generalized Multi-Protocol Label Switching (GMPLS) Signaling RSVP-TE that communicate with other NEs to exchange routes, and then selects those routes based on one or more routing metrics. Thus, the NEs 770A-H (e.g., the compute resource(s) 712 executing the control communication and configuration module(s) 732A-R) perform their responsibility for participating in controlling how data (e.g., packets) is to be routed (e.g., the next hop for the data and the outgoing physical NI for that data) by distributively determining the reachability within the network and calculating their respective forwarding information. Routes and adjacencies are stored in one or more routing structures (e.g., Routing Information Base (RIB), Label Information Base (LIB), one or more adjacency structures) on the ND control plane 724. The ND control plane 724 programs the ND forwarding plane 726 with information (e.g., adjacency and route information) based on the routing structure(s). For example, the ND control plane 724 programs the adjacency and route information into one or more forwarding table(s) 734A-R (e.g., Forwarding Information Base (FIB), Label Forwarding Information Base (LFIB), and one or more adjacency structures) on the ND forwarding plane 726. For layer 2 forwarding, the ND can store one or more bridging tables that are used to forward data based on the layer 2 information in that data. While the above example uses the special-purpose network device 702, the same distributed approach 772 can be implemented on the general purpose network device 704 and the hybrid network device 706.

FIG. 7D illustrates that a centralized approach 774 (also known as software defined networking (SDN)) that decouples the system that makes decisions about where traffic is sent from the underlying systems that forwards traffic to the selected destination. The illustrated centralized approach 774 has the responsibility for the generation of reachability and forwarding information in a centralized control plane 776 (sometimes referred to as a SDN control module, controller, network controller, OpenFlow controller, SDN controller, control plane node, network virtualization authority, or management control entity), and thus the process of neighbor discovery and topology discovery is centralized. The centralized control plane 776 has a south bound interface 782 with a data plane 780 (sometime referred to the infrastructure layer, network forwarding plane, or forwarding plane (which should not be confused with a ND forwarding plane)) that includes the NEs 770A-H (sometimes referred to as switches, forwarding elements, data plane elements, or nodes). The centralized control plane 776 includes a network controller 778, which includes a centralized reachability and forwarding information module 779 that determines the reachability within the network and distributes the forwarding information to the NEs 770A-H of the data plane 780 over the south bound interface 782 (which may use the OpenFlow protocol). Thus, the network intelligence is centralized in the centralized control plane 776 executing on electronic devices that are typically separate from the NDs.

For example, where the special-purpose network device 702 is used in the data plane 780, each of the control communication and configuration module(s) 732A-R of the ND control plane 724 typically include a control agent that provides the VNE side of the south bound interface 782. In this case, the ND control plane 724 (the compute resource(s) 712 executing the control communication and configuration module(s) 732A-R) performs its responsibility for participating in controlling how data (e.g., packets) is to be routed (e.g., the next hop for the data and the outgoing physical NI for that data) through the control agent communicating with the centralized control plane 776 to receive the forwarding information (and in some cases, the reachability information) from the centralized reachability and forwarding information module 779 (it should be understood that in some embodiments of the invention, the control communication and configuration module(s) 732A-R, in addition to communicating with the centralized control plane 776, may also play some role in determining reachability and/or calculating forwarding information—albeit less so than in the case of a distributed approach; such embodiments are generally considered to fall under the centralized approach 774, but may also be considered a hybrid approach).

While the above example uses the special-purpose network device 702, the same centralized approach 774 can be implemented with the general purpose network device 704 (e.g., each of the VNE 760A-R performs its responsibility for controlling how data (e.g., packets) is to be routed (e.g., the next hop for the data and the outgoing physical NI for that data) by communicating with the centralized control plane 776 to receive the forwarding information (and in some cases, the reachability information) from the centralized reachability and forwarding information module 779; it should be understood that in some embodiments of the invention, the VNEs 760A-R, in addition to communicating with the centralized control plane 776, may also play some role in determining reachability and/or calculating forwarding information—albeit less so than in the case of a distributed approach) and the hybrid network device 706. In fact, the use of SDN techniques can enhance the NFV techniques typically used in the general purpose network device 704 or hybrid network device 706 implementations as NFV is able to support SDN by providing an infrastructure upon which the SDN software can be run, and NFV and SDN both aim to make use of commodity server hardware and physical switches.

FIG. 7D also shows that the centralized control plane 776 has a north bound interface 784 to an application layer 786, in which resides application(s) 788. The centralized control plane 776 has the ability to form virtual networks 792 (sometimes referred to as a logical forwarding plane, network services, or overlay networks (with the NEs 770A-H of the data plane 780 being the underlay network)) for the application(s) 788. Thus, the centralized control plane 776 maintains a global view of all NDs and configured NEs/VNEs, and it maps the virtual networks to the underlying NDs efficiently (including maintaining these mappings as the physical network changes either through hardware (ND, link, or ND component) failure, addition, or removal).

While FIG. 7D shows the distributed approach 772 separate from the centralized approach 774, the effort of network control may be distributed differently or the two combined in certain embodiments of the invention. For example: 1) embodiments may generally use the centralized approach (SDN) 774, but have certain functions delegated to the NEs (e.g., the distributed approach may be used to implement one or more of fault monitoring, performance monitoring, protection switching, and primitives for neighbor and/or topology discovery); or 2) embodiments of the invention may perform neighbor discovery and topology discovery via both the centralized control plane and the distributed protocols, and the results compared to raise exceptions where they do not agree. Such embodiments are generally considered to fall under the centralized approach 774, but may also be considered a hybrid approach.

While FIG. 7D illustrates the simple case where each of the NDs 700A-H implements a single NE 770A-H, it should be understood that the network control approaches described with reference to FIG. 7D also work for networks where one or more of the NDs 700A-H implement multiple VNEs (e.g., VNEs 730A-R, VNEs 760A-R, those in the hybrid network device 706). Alternatively or in addition, the network controller 778 may also emulate the implementation of multiple VNEs in a single ND. Specifically, instead of (or in addition to) implementing multiple VNEs in a single ND, the network controller 778 may present the implementation of a VNE/NE in a single ND as multiple VNEs in the virtual networks 792 (all in the same one of the virtual network(s) 792, each in different ones of the virtual network(s) 792, or some combination). For example, the network controller 778 may cause an ND to implement a single VNE (a NE) in the underlay network, and then logically divide up the resources of that NE within the centralized control plane 776 to present different VNEs in the virtual network(s) 792 (where these different VNEs in the overlay networks are sharing the resources of the single VNE/NE implementation on the ND in the underlay network).

On the other hand, FIGS. 7E and 7F respectively illustrate exemplary abstractions of NEs and VNEs that the network controller 778 may present as part of different ones of the virtual networks 792. FIG. 7E illustrates the simple case of where each of the NDs 700A-H implements a single NE 770A-H (see FIG. 7D), but the centralized control plane 776 has abstracted multiple of the NEs in different NDs (the NEs 770A-C and G-H) into (to represent) a single NE 7701 in one of the virtual network(s) 792 of FIG. 7D, according to some embodiments of the invention. FIG. 7E shows that in this virtual network, the NE 7701 is coupled to NE 770D and 770F, which are both still coupled to NE 770E.

FIG. 7F illustrates a case where multiple VNEs (VNE 770A.1 and VNE 770H.1) are implemented on different NDs (ND 700A and ND 700H) and are coupled to each other, and where the centralized control plane 776 has abstracted these multiple VNEs such that they appear as a single VNE 770T within one of the virtual networks 792 of FIG. 7D, according to some embodiments of the invention. Thus, the abstraction of a NE or VNE can span multiple NDs.

While some embodiments of the invention implement the centralized control plane 776 as a single entity (e.g., a single instance of software running on a single electronic device), alternative embodiments may spread the functionality across multiple entities for redundancy and/or scalability purposes (e.g., multiple instances of software running on different electronic devices).

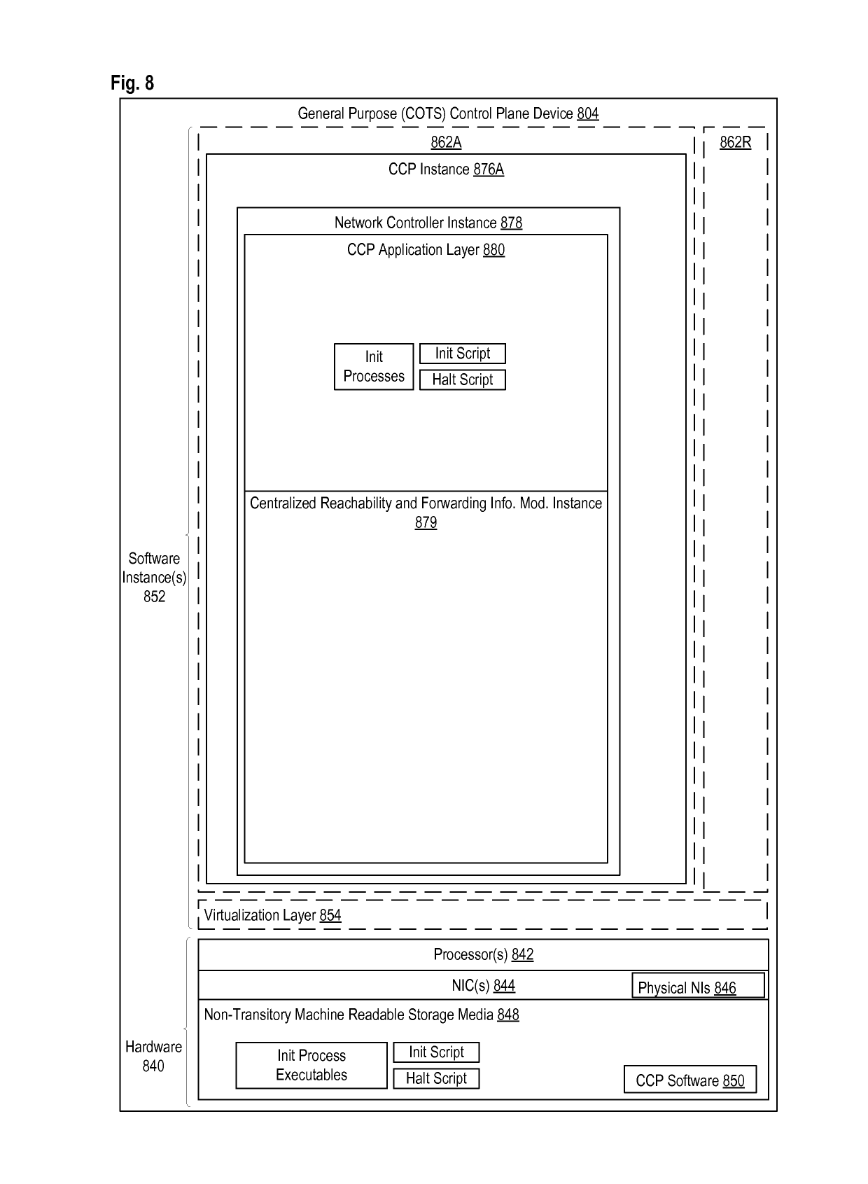

Similar to the network device implementations, the electronic device(s) running the centralized control plane 776, and thus the network controller 778 including the centralized reachability and forwarding information module 779, may be implemented a variety of ways (e.g., a special purpose device, a general-purpose (e.g., COTS) device, or hybrid device). These electronic device(s) would similarly include compute resource(s), a set or one or more physical NICs, and a non-transitory machine-readable storage medium having stored thereon the centralized control plane software. For instance, FIG. 8 illustrates, a general purpose control plane device 804 including hardware 840 comprising a set of one or more processor(s) 842 (which are often COTS processors) and network interface controller(s) 844 (NICs; also known as network interface cards) (which include physical NIs 846), as well as non-transitory machine readable storage media 848 having stored therein centralized control plane (CCP) software 850.

In embodiments that use compute virtualization, the processor(s) 842 typically execute software to instantiate a virtualization layer 854 and software container(s) 862A-R (e.g., with operating system-level virtualization, the virtualization layer 854 represents the kernel of an operating system (or a shim executing on a base operating system) that allows for the creation of multiple software containers 862A-R (representing separate user space instances and also called virtualization engines, virtual private servers, or jails) that may each be used to execute a set of one or more applications; with full virtualization, the virtualization layer 854 represents a hypervisor (sometimes referred to as a virtual machine monitor (VMM)) or a hypervisor executing on top of a host operating system, and the software containers 862A-R each represent a tightly isolated form of software container called a virtual machine that is run by the hypervisor and may include a guest operating system; with para-virtualization, an operating system or application running with a virtual machine may be aware of the presence of virtualization for optimization purposes). Again, in embodiments where compute virtualization is used, during operation an instance of the CCP software 850 (illustrated as CCP instance 876A) is executed within the software container 862A on the virtualization layer 854. In embodiments where compute virtualization is not used, the CCP instance 876A on top of a host operating system is executed on the “bare metal” general purpose control plane device 804. The instantiation of the CCP instance 876A, as well as the virtualization layer 854 and software containers 862A-R if implemented, are collectively referred to as software instance(s) 852.

In some embodiments, the CCP instance 876A includes a network controller instance 878. The network controller instance 878 includes a centralized reachability and forwarding information module instance 879 (which is a middleware layer providing the context of the network controller 778 to the operating system and communicating with the various NEs), and an CCP application layer 880 (sometimes referred to as an application layer) over the middleware layer (providing the intelligence required for various network operations such as protocols, network situational awareness, and user—interfaces). At a more abstract level, this CCP application layer 880 within the centralized control plane 776 works with virtual network view(s) (logical view(s) of the network) and the middleware layer provides the conversion from the virtual networks to the physical view.

The centralized control plane 776 transmits relevant messages to the data plane 780 based on CCP application layer 880 calculations and middleware layer mapping for each flow. A flow may be defined as a set of packets whose headers match a given pattern of bits; in this sense, traditional IP forwarding is also flow—based forwarding where the flows are defined by the destination IP address for example; however, in other implementations, the given pattern of bits used for a flow definition may include more fields (e.g., 10 or more) in the packet headers. Different NDs/NEs/VNEs of the data plane 780 may receive different messages, and thus different forwarding information. The data plane 780 processes these messages and programs the appropriate flow information and corresponding actions in the forwarding tables (sometime referred to as flow tables) of the appropriate NE/VNEs, and then the NEs/VNEs map incoming packets to flows represented in the forwarding tables and forward packets based on the matches in the forwarding tables.

Standards such as OpenFlow define the protocols used for the messages, as well as a model for processing the packets. The model for processing packets includes header parsing, packet classification, and making forwarding decisions. Header parsing describes how to interpret a packet based upon a well-known set of protocols. Some protocol fields are used to build a match structure (or key) that will be used in packet classification (e.g., a first key field could be a source media access control (MAC) address, and a second key field could be a destination MAC address).

Packet classification involves executing a lookup in memory to classify the packet by determining which entry (also referred to as a forwarding table entry or flow entry) in the forwarding tables best matches the packet based upon the match structure, or key, of the forwarding table entries. It is possible that many flows represented in the forwarding table entries can correspond/match to a packet; in this case the system is typically configured to determine one forwarding table entry from the many according to a defined scheme (e.g., selecting a first forwarding table entry that is matched). Forwarding table entries include both a specific set of match criteria (a set of values or wildcards, or an indication of what portions of a packet should be compared to a particular value/values/wildcards, as defined by the matching capabilities—for specific fields in the packet header, or for some other packet content), and a set of one or more actions for the data plane to take on receiving a matching packet. For example, an action may be to push a header onto the packet, for the packet using a particular port, flood the packet, or simply drop the packet. Thus, a forwarding table entry for IPv4/IPv6 packets with a particular transmission control protocol (TCP) destination port could contain an action specifying that these packets should be dropped.

Making forwarding decisions and performing actions occurs, based upon the forwarding table entry identified during packet classification, by executing the set of actions identified in the matched forwarding table entry on the packet.

However, when an unknown packet (for example, a “missed packet” or a “match-miss” as used in OpenFlow parlance) arrives at the data plane 780, the packet (or a subset of the packet header and content) is typically forwarded to the centralized control plane 776. The centralized control plane 776 will then program forwarding table entries into the data plane 780 to accommodate packets belonging to the flow of the unknown packet. Once a specific forwarding table entry has been programmed into the data plane 780 by the centralized control plane 776, the next packet with matching credentials will match that forwarding table entry and take the set of actions associated with that matched entry.

A network interface (NI) may be physical or virtual; and in the context of IP, an interface address is an IP address assigned to a NI, be it a physical NI or virtual NI. A virtual NI may be associated with a physical NI, with another virtual interface, or stand on its own (e.g., a loopback interface, a point-to-point protocol interface). A NI (physical or virtual) may be numbered (a NI with an IP address) or unnumbered (a NI without an IP address). A loopback interface (and its loopback address) is a specific type of virtual NI (and IP address) of a NE/VNE (physical or virtual) often used for management purposes; where such an IP address is referred to as the nodal loopback address. The IP address(es) assigned to the NI(s) of a ND are referred to as IP addresses of that ND; at a more granular level, the IP address(es) assigned to NI(s) assigned to a NE/VNE implemented on a ND can be referred to as IP addresses of that NE/VNE.

Some portions of the preceding detailed descriptions have been presented in terms of algorithms and symbolic representations of transactions on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of transactions leading to a desired result. The transactions are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The algorithms and displays presented herein are not inherently related to any particular computer or other apparatus. Various general-purpose systems may be used with programs in accordance with the teachings herein, or it may prove convenient to construct more specialized apparatus to perform the required method transactions. The required structure for a variety of these systems will appear from the description above. In addition, embodiments of the present invention are not described with reference to any particular programming language. It will be appreciated that a variety of programming languages may be used to implement the teachings of embodiments of the invention as described herein.

In the foregoing specification, embodiments of the invention have been described with reference to specific exemplary embodiments thereof. It will be evident that various modifications may be made thereto without departing from the broader spirit and scope of the invention as set forth in the following claims. The specification and drawings are, accordingly, to be regarded in an illustrative sense rather than a restrictive sense.

Throughout the description, embodiments of the present invention have been presented through flow diagrams. It will be appreciated that the order of transactions and transactions described in these flow diagrams are only intended for illustrative purposes and not intended as a limitation of the present invention. One having ordinary skill in the art would recognize that variations can be made to the flow diagrams without departing from the broader spirit and scope of the invention as set forth in the following claims.

What is claimed is:

1. A method in a first network device for performing a software upgrade, the method comprising:
receiving, by a first init process executing on a first root file system, an indication to perform an in-service software upgrade (ISSU);
releasing, by the first init process in response to receiving the indication to perform the ISSU, the first root file system by:
setting an indication that the ISSU is in progress, and
terminating processes executing on the first root file system;
switching, by the first init process in response to receiving the indication to perform the ISSU, from the first root file system to a second root file system by:
moving a root from the first root file system to the second root file system, wherein the second root file system includes an upgraded software,
moving critical system files from the first root file system to the second root file system,
unmounting the first root file system, and
executing a second init process on the second root file system; and
initializing, by the second init process executing on the second root file system, the second root file system by:
starting processes on the second root file system.

2. The method of claim 1, wherein releasing the first root file system further comprises:
preventing, in response detecting the indication that the ISSU is in progress, unmounting of critical system files residing on the first root file system, thereby avoiding rebooting of a kernel.

3. The method of claim 1, wherein releasing the first root file system further comprises:
preventing, in response detecting the indication that the ISSU is in progress, unloading of loadable kernel modules (LKMs), thereby avoiding resetting of peripheral devices connected to the first network device.

4. The method of claim 1, wherein initializing the second root file system further comprises:
preventing, in response detecting the indication that the ISSU is in progress, mounting of critical system files on the second root file system.

5. The method of claim 1, wherein initializing the second root file system further comprises:
preventing, in response detecting the indication that the ISSU is in progress, loading of loadable kernel modules (LKMs).

6. The method of claim 1, wherein initializing the second root file system further comprises:
preventing, in response detecting the indication that the ISSU is in progress, resetting of hardware devices connected to the first network device.

7. The method of claim 1, wherein releasing the first root file system further comprises executing a halt script, and wherein the halt script is configured to, in response detecting the indication that the ISSU is in progress, prevent unmounting of critical system files residing on the first root file system.

8. The method of claim 1, wherein releasing the first root file system further comprises executing a halt script, and wherein the halt script is configured to, in response detecting the indication that the ISSU is in progress, prevent unloading of loadable kernel modules (LKMs).

9. The method of claim 1, wherein initializing the second root file system further comprises executing an init script, and wherein the init script is configured to, in response detecting the indication that the ISSU is in progress, prevent mounting of critical system files on the second root file system.

10. The method of claim 1, wherein initializing the second root file system further comprises executing an init script, and wherein the init script is configured to, in response detecting the indication that the ISSU is in progress, prevent loading of loadable kernel modules (LKMs).

11. The method of claim 1, wherein initializing the second root file system further comprises executing an init script, and wherein the init script is configured to, in response detecting the indication that the ISSU is in progress, prevent resetting of hardware devices connected to the first network device.

12. A first network device for performing a software upgrade, the first network device comprising:
a set of one or more processors; and
a non-transitory machine-readable storage medium containing code, which when executed by the set of one or more processors, causes the first network device to:
receive, by a first init process executing on a first root file system, an indication to perform an in-service software upgrade (ISSU);
release, by the first init process in response to receiving the indication to perform the ISSU, the first root file system by:
setting an indication that the ISSU is in progress, and
terminating processes executing on the first root file system;
switch, by the first init process in response to receiving the indication to perform the ISSU, from the first root file system to a second root file system by:
moving a root from the first root file system to the second root file system, wherein the second root file system includes an upgraded software,
moving critical system files from the first root file system to the second root file system,
unmounting the first root file system, and
executing a second init process on the second root file system; and
initialize, by the second init process executing on the second root file system, the second root file system by:
starting processes on the second root file system.

13. The first network device of claim 12, wherein releasing the first root file system further comprises the first init process to:
prevent, in response detecting the indication that the ISSU is in progress, unmounting of critical system files residing on the first root file system, thereby avoiding rebooting of a kernel.

14. The first network device of claim 12, wherein releasing the first root file system further comprises the first init process to:
prevent, in response detecting the indication that the ISSU is in progress, unloading of loadable kernel modules (LKMs), thereby avoiding resetting of peripheral devices connected to the first network device.

15. The first network device of claim 12, wherein initializing the second root file system further comprises the second init process to:
prevent, in response detecting the indication that the ISSU is in progress, mounting of critical system files on the second root file system.

16. The first network device of claim 12, wherein initializing the second root file system further comprises the second init process to:
prevent, in response detecting the indication that the ISSU is in progress, loading of loadable kernel modules (LKMs).

17. The first network device of claim 12, wherein initializing the second root file system further comprises the second init process to:
prevent, in response detecting the indication that the ISSU is in progress, resetting of hardware devices connected to the first network device.

18. The first network device of claim 12, wherein releasing the first root file system further comprises the first init process to execute a halt script, and wherein the halt script is configured to, in response detecting the indication that the ISSU is in progress, prevent unmounting of critical system files residing on the first root file system.

19. The first network device of claim 12, wherein releasing the first root file system further comprises the first init process to execute a halt script, and wherein the halt script is configured to, in response detecting the indication that the ISSU is in progress, prevent unloading of loadable kernel modules (LKMs).

20. The first network device of claim 12, wherein initializing the second root file system further comprises the second init process to execute an init script, and wherein the init script is configured to, in response detecting the indication that the ISSU is in progress, prevent mounting of critical system files on the second root file system.

21. The first network device of claim 12, wherein initializing the second root file system further comprises the second init process to execute an init script, and wherein the init script is configured to, in response detecting the indication that the ISSU is in progress, prevent loading of loadable kernel modules (LKMs).

22. The first network device of claim 12, wherein initializing the second root file system further comprises the second init process to execute an init script, and wherein the init script is configured to, in response detecting the indication that the ISSU is in progress, prevent resetting of hardware devices connected to the first network device.

23. A non-transitory machine-readable storage medium having computer code stored therein, which when executed by a set of one or more processors of a first network device for performing a software upgrade, causes the first network device to perform operations comprising:
receiving, by a first init process executing on a first root file system, an indication to perform an in-service software upgrade (ISSU);
releasing, by the first init process in response to receiving the indication to perform the ISSU, the first root file system by:
setting an indication that the ISSU is in progress, and
terminating processes executing on the first root file system;
switching, by the first init process in response to receiving the indication to perform the ISSU, from the first root file system to a second root file system by:
moving a root from the first root file system to the second root file system, wherein the second root file system includes an upgraded software,
moving critical system files from the first root file system to the second root file system,
unmounting the first root file system, and
executing a second init process on the second root file system; and
initializing, by the second init process executing on the second root file system, the second root file system by:
starting processes on the second root file system.

24. The non-transitory machine-readable storage medium of claim 23, wherein releasing the first root file system further comprises:
preventing, in response detecting the indication that the ISSU is in progress, unmounting of critical system files residing on the first root file system, thereby avoiding rebooting of a kernel.

25. The non-transitory machine-readable storage medium of claim 23, wherein releasing the first root file system further comprises:
preventing, in response detecting the indication that the ISSU is in progress, unloading of loadable kernel modules (LKMs), thereby avoiding resetting of peripheral devices connected to the first network device.

26. The non-transitory machine-readable storage medium of claim 23, wherein initializing the second root file system further comprises:
preventing, in response detecting the indication that the ISSU is in progress, mounting of critical system files on the second root file system.

27. The non-transitory machine-readable storage medium of claim 23, wherein initializing the second root file system further comprises:
preventing, in response detecting the indication that the ISSU is in progress, loading of loadable kernel modules (LKMs).

28. The non-transitory machine-readable storage medium of claim 23, wherein initializing the second root file system further comprises:
preventing, in response detecting the indication that the ISSU is in progress, resetting of hardware devices connected to the first network device.

29. The non-transitory machine-readable storage medium of claim 23, wherein releasing the first root file system further comprises executing a halt script, and wherein the halt script is configured to, in response detecting the indication that the ISSU is in progress, prevent unmounting of critical system files residing on the first root file system.

30. The non-transitory machine-readable storage medium of claim 23, wherein releasing the first root file system further comprises executing a halt script, and wherein the halt script is configured to, in response detecting the indication that the ISSU is in progress, prevent unloading of loadable kernel modules (LKMs).

31. The non-transitory machine-readable storage medium of claim 23, wherein initializing the second root file system further comprises executing an init script, and wherein the init script is configured to, in response detecting the indication that the ISSU is in progress, prevent mounting of critical system files on the second root file system.

32. The non-transitory machine-readable storage medium of claim 23, wherein initializing the second root file system further comprises executing an init script, and wherein the init script is configured to, in response detecting the indication that the ISSU is in progress, prevent loading of loadable kernel modules (LKMs).

33. The non-transitory machine-readable storage medium of claim 23, wherein initializing the second root file system further comprises executing an init script, and wherein the init script is configured to, in response detecting the indication that the ISSU is in progress, prevent resetting of hardware devices connected to the first network device.
